(19) United States
(12) Patent Application Publication
(10) Pub. No.: US 2025/0225556 A1
(43) Pub. Date: Jul. 10, 2025

(54) METHOD AND SYSTEM FOR PROVIDING VERIFIED BUYER RATINGS TO SELLERS

(71) Applicant: Mastercard International Incorporated, Purchase, NY (US)

(72) Inventors: Samrat RAJ, Scarsdale, NY (US); Mark David CORRITORI, Somers, NY (US); Molly BASKIN, Stamford, CT (US); Rohit CHHAJED, Stamford, CT (US)

(73) Assignee: Mastercard International Incorporated, Purchase, NY (US)

(21) Appl. No.: 18/407,839

(22) Filed: Jan. 9, 2024

(51) Int. Cl. G06Q 30/0601

(52) U.S. Cl. CPC G06Q 30/0609

(57) ABSTRACT

A method for generating a verified buyer rating for a buyer in a proposed payment transaction includes: storing an account profile associated with a transaction account including an account identifier and transaction data for a plurality of processed payment transactions funded by the transaction account; receiving a plurality of transaction values for the proposed payment transaction funded by the transaction account; and generating the verified buyer rating based on one or more transactional metrics, the one or more transactional metrics based on the transaction data for the plurality of processed payment transactions and a comparison of the plurality of transaction data values for the proposed payment transaction with the transaction data for one or more of the plurality of processed payment transactions.

### FIELD

The present disclosure relates to providing verified buyer ratings to sellers, specifically to the generation of a verified buyer rating for a buyer of a proposed transaction using past transaction data and other available data sources.

### BACKGROUND

When a consumer is interested in purchasing a product from a merchant, they are often provided with a number of protections. Many jurisdictions have laws and regulations regarding the ability for a consumer to return or refund a purchase, and many payment instruments often provide additional protections, such as through chargebacks and other processes. In addition, many websites can provide information on the authenticity of a merchant and past transaction histories for a consumer to review prior to proceeding with a purchase. As a result, consumers can often proceed with a transaction with the knowledge that the merchant they are transacting with is genuine and they are protected if they are unhappy with their purchase.

However, merchants are not provided with the same knowledge and protections as consumers. Currently, merchants have little recourse, if any, for fraudulent purchases made by consumers. Large merchants that participate in a large volume of transactions can often absorb the losses from such purchases, but small businesses are often significantly negatively impacted by consumers that engage in fraudulent or otherwise problematic activity. Some online marketplaces enable sellers to leave feedback or ratings for buyers related to individual transactions to help alleviate these problems. However, such ratings are only available on that same marketplace and are limited to a buyer's activity on that marketplace and using the same account where the feedback was left, providing no protection if the buyer uses a different account or makes a purchase on a different marketplace or directly with a merchant. Thus, there is a need for a technological improvement that can provide merchants or other sellers with accurate ratings on buyers for potential transactions.

### SUMMARY

The present disclosure provides a description of systems and methods for generating verified buyer ratings for buyers in proposed payment transactions. When a buyer proposes a new transaction with a seller, the seller can provide information for the transaction along with information identifying the transaction account that is to be used to fund the transaction to a processor. The processor can identify past transactions involving the same transaction account and generate metrics based on the past transaction activity for the transaction account along with the information for the new transaction and any other available data sources, and use the generated metrics to generate a verified buyer rating for the buyer, which can represent the likelihood that the buyer will successfully fund the transaction and not later chargeback the transaction. Such metrics can use transaction frequency, the buyer's spending habits in the same or similar industries, length of transaction history, and other data in determining the rating. The verified buyer rating can be provided to the seller, who can then decide whether or not to proceed with the transaction based on the rating. In some cases, the verified buyer rating can be used to automatically proceed with or decline the transaction on behalf of the seller, providing for an automated process that protects sellers from potentially negative buyer interactions. The result is protection for sellers that is platform agnostic and can be performed without requiring buyers or sellers to provide any information beyond the data already used in transactions, allowing for an overall more secure and convenient shopping experience without disrupting existing practices.

A method for generating a verified buyer rating for a buyer in a proposed payment transaction includes: storing, in an account database of a processing server, an account profile associated with a transaction account including at least an account identifier and transaction data for a plurality of processed payment transactions funded by the associated transaction account, wherein the transaction data includes at least one of: transaction amount, merchant identifier, merchant category code, geographic location, and transaction time; receiving, by a receiver of the processing server, a plurality of transaction values for the proposed payment transaction funded by the associated transaction account from a computing device, wherein the plurality of transactions values includes at least the account identifier; and generating, by a processor of the processing server, the verified buyer rating based on one or more transactional metrics, the one or more transactional metrics based on at least the transaction data for the plurality of processed payment transactions and a comparison of the plurality of transaction data values for the proposed payment transaction with the transaction data for one or more of the plurality of processed payment transactions.

A system for generating a verified buyer rating for a buyer in a proposed payment transaction includes: a computing device; and a processing server, the processing server including an account database storing an account profile associated with a transaction account including at least an account identifier and transaction data for a plurality of processed payment transactions funded by the associated transaction account, wherein the transaction data includes at least one of: transaction amount, merchant identifier, merchant category code, geographic location, and transaction time, a receiver receiving a plurality of transaction values for the proposed payment transaction funded by the associated transaction account from the computing device, wherein the plurality of transactions values includes at least the account identifier, and a processor generating the verified buyer rating based on one or more transactional metrics, the one or more transactional metrics based on at least the transaction data for the plurality of processed payment transactions and a comparison of the plurality of transaction data values for the proposed payment transaction with the transaction data for one or more of the plurality of processed payment transactions.

A method for processing financial transactions using verified buyer ratings, the method includes: communicating, by a first computing device, with a second computing device, and receiving, from the second computing device, payment details associated with a payment transaction initiated by the second computing device with the first computing device, wherein the payment details include at least a transaction account identifier; prior to submitting an authorization request to a payment network for processing, transmitting, by the first computing device, via an application programming interface, a verified buyer rating request to a processing server, wherein the verified buyer rating request includes at least the transaction account identifier included in the received payment details, and wherein the processing server generates a verified buyer rating on a basis of applying a machine learning algorithm on at least a transaction history of a transaction account associated with the transaction account identifier; receiving, by the first computing device, the verified buyer rating, via the application programming interface from the processing server, wherein the verified buyer rating indicates a likelihood of a successfully funded transaction; and determining, by the first computing device, whether to proceed with the payment transaction on a basis of a value of the verified buyer rating relative to a predetermined threshold value, wherein when the value of the verified buyer rating exceeds the predetermined threshold value, the method further includes automatically proceeding, by the first computing device, with the payment transaction by transmitting an authorization request to a payment network for processing.

A system for processing financial transactions using verified buyer ratings includes a receiving device, of a first computing device, configured to communicate with a second computing device, and receive, from the second computing device, payment details associated with a payment transaction initiated by the second computing device with the first computing device, wherein the payment details include at least a transaction account identifier; a transmitting device, of the first computing device, configured to transmit, via an application programming interface, prior to submitting an authorization request to a payment network for processing, a verified buyer rating request to a processing server, wherein the verified buyer rating request includes at least the transaction account identifier included in the received payment details, and wherein the processing server generates a verified buyer rating on a basis of applying a machine learning algorithm on at least a transaction history of a transaction account associated with the transaction account identifier; and a processing device, of the first computing device, wherein the receiving device is further configured to receive the verified buyer rating, via the application programming interface, from the processing server, the verified buyer rating indicating a likelihood of a successfully funded transaction, the processing device is configured to determine whether to proceed with the payment transaction on a basis of a value of the verified buyer rating relative to a predetermined threshold value, and automatically proceed with the payment transaction, when the value of the verified buyer rating exceeds the predetermined threshold value, by transmitting an authorization request to a payment network for processing.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture generating a verified buyer rating in a proposed payment transaction in accordance with exemplary embodiments.

FIG. 2 is a block diagram illustrating the processing server in the system of FIG. 1 for generating a verified buyer rating in a proposed payment transaction in accordance with exemplary embodiments.

FIG. 3 is a flow diagram illustrating a process for generating a verified buyer rating in a proposed payment transaction in the system of FIG. 1 in accordance with exemplary embodiments.

FIG. 4 is a flow chart illustrating an exemplary method for generating a verified buyer rating in a proposed payment transaction in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

### System for Generating Verified Buyer Ratings

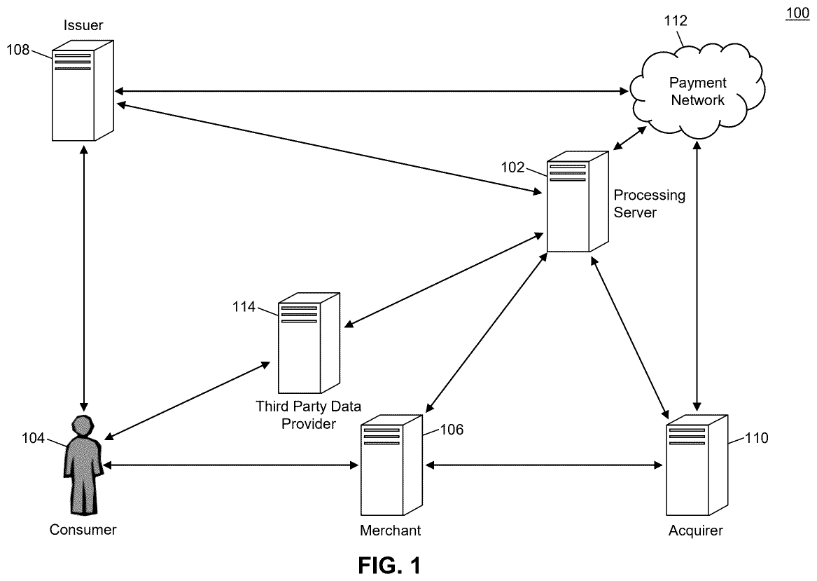

FIG. 1 illustrates a system 100 for the generation of verified buyer ratings for buyers in proposed payment transactions based on transaction histories and other available data. The system 100 can include a processing server 102. The processing server 102, discussed in more detail below, can be configured to generate verified buyer ratings for a buyer in a proposed payment transaction based on at least past transaction activity for the transaction account used by the buyer and any other available data.

In the system 100, a consumer 104 can be interested in purchasing a product from a merchant 106. The merchant 106 can be a small business, large business, individual, or any other entity that is selling a product in exchange for currency from the consumer 104 using any suitable platform or method. As discussed herein, merchant 106 can refer to the merchant as an entity or computing systems associated with the merchant entity for performing functions discussed herein.

The system 100 can also include an issuer 108. As used herein, issuer 108 can refer to the issuer as an entity or computing systems associated with the issuer entity for performing functions discussed herein. The issuer 108 can be an entity that issues a transaction account to the consumer 104 for use in funding payment transactions, such as a bank, other financial institution, or any other entity that issues transaction accounts to consumers. The issuer 108 can issue a payment instrument to the consumer 104 for use in conveying payment details for the transaction account when making a purchase, such as a credit card, debit card, charge card, prepaid card, check, electronic wallet, automated teller machine card, etc. An issued transaction account can include at least a payment account number or other unique identifier directly associated with the transaction account. Payment details for the transaction account can include the payment account number and any other data used in the authentication of the transaction account and identification of the issuer 108 for use in processing of payment transactions funded via the transaction account, such as a bank identification number, expiration date, name, billing address, security code, etc.

When the consumer 104 is interested in purchasing a product from the merchant 106, the consumer 104 can provide the payment details for the transaction account they wish to use to fund the transaction to the merchant 106 using any suitable method. For example, the consumer 104 can present a payment card to a point of sale of the merchant 106 that can read the payment details therefrom using magnetic stripe, integrated circuit chip, or near field communication, or the consumer 104 can enter the payment details into a web page or application program associated with the merchant 106.

Traditionally, after the consumer 104 provides payment details to the merchant 106, the merchant 106 can combine the payment details with other information regarding the payment transaction and submit the transaction data to an acquirer 110 for processing of the payment transaction. As used herein, acquirer 110 can refer to an entity or computing systems associated with the acquirer entity for performing functions discussed herein. The acquirer 110 can be an entity that can process payment transactions on behalf of the merchant 106. The acquirer 110 can be a bank, other financial institution, or any other entity that issues a transaction account to the merchant 106 for use in receiving payment in payment transactions. The acquirer 110 can exchange funds with issuers 108 in instances where consumers 104 transacts via a transaction account issued by the issuer 108 to a merchant 106 represented by the acquirer 110.

The merchant 106 can submit the transaction data for the payment transaction to the acquirer 110 using any suitable method. The acquirer 110 can receive the transaction data and submit an authorization request for the payment transaction to a payment network 112. The authorization request can be a specially formatted transaction message that is formatted pursuant to one or more standards governing the exchange of financial transaction messages, such as the International Organization of Standardization's ISO 8583 or ISO 20022 standards. The transaction message can include a plurality of data elements, each of which can be configured to store one or more data values for the transaction, such as payment details, transaction amount, transaction time and/or date, merchant identification number, bank identification number, merchant category code, currency type, payment type, point of sale data, product data, etc. The transaction message can also include a message type indicator that is indicative of a type of the transaction message, such as an authorization request for the transaction message submitted from the acquirer 110 to the payment network 112 for processing.

The payment network 112 can be a network or system that is used for the transfer of money via the use of cash-substitutes for thousands, millions, and even billions of transactions during a given period. Payment networks 112 can use a variety of different protocols and procedures in order to process the transfer of money for various types of transactions. Transactions that can be performed via a payment network 112 can include product or service purchases, credit purchases, debit transactions, fund transfers, account withdrawals, etc. Payment networks 112 can be configured to perform transactions via cash-substitutes, which can include payment cards, letters of credit, checks, transaction accounts, etc. Examples of networks or systems configured to perform as payment networks 112 include those operated by Mastercard®, VISA®, Discover®, American Express®, PayPal®, etc. As used herein, payment network 112 can refer to both the payment network as an entity, and the physical payment network, such as the equipment, hardware, and software comprising the payment network. Such infrastructure comprising a physical payment network can also be referred to as payment rails.

For the transaction, the acquirer 110 can submit the authorization request for the payment transaction to the payment network 112 via the payment rails. In some cases, the merchant 108 can generate the authorization request, which can be submitted to the acquirer 110 and forwarded to the payment network 112. In other cases, the merchant 108 can submit the transaction data to the acquirer 110, which can generate the authorization request based thereon for transmission to the payment network 112. The payment network 112 can receive the authorization request and route the authorization request to the issuer 108 to approve or decline the payment transaction, where the issuer 108 can be identified via the payment details stored in the corresponding data element(s) in the authorization request. The payment network 112 can identify the issuer 108 and electronically transmit the authorization request to the issuer 108 via the payment rails of the payment network 112. In some cases, the payment network 112 can perform one or more value added service prior to routing the authorization request to the issuer 108, such as fraud scoring, on-behalf processing, etc.

The issuer 108 can receive the authorization request and determine whether to approve or decline the payment transaction. The issuer 108 can identify the transaction account selected for use in funding the payment transaction via the payment details stored in the corresponding data element(s) in the authorization request and use traditional methods to determine whether or not to approve or decline the transaction. For instance, the issuer 108 can determine if an account balance or available credit for the transaction account is greater than or equal to the transaction amount for the payment transaction. The issuer 108 can also determine whether to approve or decline the payment transaction based on any other applicable data, such as account controls placed on the transaction account by the consumer 104. The issuer 108 can generate an authorization response for the payment transaction, which is a transaction message that includes a message type indicator indicative of an authorization response and includes a data element configured to store a response code for the payment transaction that indicates if the payment transaction is approved or declined, and, if declined, can indicate a reason that the payment transaction is declined. In some cases, the authorization response can be a newly generated transaction message. In other cases, the issuer 108 can modify the received authorization request to generate the authorization response.

Once the issuer 108 has approved or declined the payment transaction, the issuer 108 can submit the authorization response to the payment network 112 via the payment rails associated therewith. The payment network 112 can forward the authorization response to the acquirer 110 via the payment rails, which can then forward the authorization response to the merchant 108 or otherwise provide the merchant 108 with an indication whether the payment transaction was approved or declined. The merchant 108 can then finalize the payment transaction accordingly, such as by notifying the consumer 104 of a declined payment transaction or providing the consumer 104 with the purchased goods or services for an approved payment transaction. Following this processing of the payment transaction, the acquirer 110 and issuer 108 can participate in clearing and settlement of the payment transaction using traditional processes.

In the system 100, the merchant 106 may be interested in obtaining a verified buyer rating for the consumer 104 prior to submitting the payment transaction for processing to protect the merchant 106 from potential fraudulent or otherwise negative activity. In order to obtain such a rating, the merchant 106 may electronically submit a verified buyer rating request to the processing server 102 using a suitable communication network and method. The verified buyer rating request may include at least the transaction account identifier included in the payment details provided by the consumer 104 and any other transaction information for the payment transaction that can be used by the processing server 102 in determining the verified buyer rating. In some embodiments, the processing server 102 may provide an application programming interface for use by the merchant 106 in submitting a verified buyer rating request. In other embodiments, the processing server 102 may be a part of the payment network 112. In such embodiments, the merchant 106 may request the verified buyer rating as part of the submitted authorization request, where such a request can be indicated in specific data element reserved for private use in the transaction message. In some cases, the processing server 102 may generate verified buyer ratings for all authorization requests received from the merchant 106 based on prior authorization of the merchant 106, where each received authorization request from the merchant 106 may be provided to the processing server 102 as a request for a verified buyer rating. In some embodiments, acquirers 110 may submit verified buyer rating requests to the processing server 102 in place of or on behalf of merchants 106.

After receiving the request, the processing server 102 may identify an account profile that is associated with the transaction account used in the proposed payment transaction using the transaction account identifier included in the request. The account profile associated with the transaction account may include a transaction history for the transaction account, which may include transaction details for past payment transactions involving the associated transaction account. The past payment transactions may include approved payment transactions, declined payment transactions, payment transactions that were successfully cleared and then charged back, returns or refunds for past payment transactions, etc. Transaction details for past payment transactions may include any data for payment transactions for which the processing server 102 is authorized to receive, such as transaction amounts, transaction times and/or dates, merchant category codes, merchant identifiers, bank identification numbers, currency types, payment types, point of sale data, product data, etc. In some embodiments, the processing server 102 may store only transaction history for a transaction account with consent of an authorized user of the transaction account, which may be provided directly by the authorized user or by the issuer 108 of the transaction account on behalf thereof. In some instances, all data stored in account profiles for transaction accounts may be stored without any personally identifiable information.

The processing server 102 may generate one or more transactional metrics for the transaction account by applying one or more machine learning algorithms on at least the transaction history included in the identified account profile and based on a comparison of the transaction history with the transaction data for the proposed payment transaction. Transactional metrics may include overall metrics for all payment transactions for the transaction account as well as metrics for categories of payment transactions, such as separated by merchant category code, time, date, geographic location, transaction amount, merchant identifier, currency type, payment type, etc. Transactional metrics may include transaction frequency, average spend, number of transactions, chargeback rate, return rate, etc. The processing server 102 may then use the generated transactional metrics to generate a verified buyer rating for the consumer 104. The verified buyer rating may indicate a likelihood that the consumer 104 will successfully fund the proposed payment transaction and may also indicate a likelihood that the consumer 104 will not later chargeback the payment transaction or return the purchased goods or services.

In one example, the consumer 104 can be attempting to purchase a pair of running shoes from the merchant 108 for $130. The metrics generated for the transaction account can identify that the consumer 104 has regularly made purchases from sporting goods stores over the course of three years that average $100 that were not charged back or returned. In such an example, the consumer 104 can be provided a very high verified buyer rating, such as 95 on a scale from 0 to 100, indicating that the merchant 108 can be very confident that the consumer 104 will follow through with their payment and not charge back the transaction. In a second example, the same consumer 104 with the same history can be attempting to purchase ten pairs of running shoes from the merchant 108 for $1300. Based on the regular purchases averaging $100, the verified buyer rating for the consumer 104 for the proposed payment transaction can be lower due to the large transaction amount being abnormal for the consumer 104 for such a purchase. If the consumer 104 has an overall history of transaction amounts well below $1300, the verified buyer rating for the proposed payment transaction could be even lower, such as a 50, as a result of the consumer's lengthy history and participation in similar transactions but lack of transactions of such high amounts. If the consumer 104 has successfully made other purchases over $1000 in other industries, the verified buyer rating for the proposed transaction could be between the other scores, such as an 80, as a result of the consumer 104 attempting a purchase much greater than typical for sporting goods, but where such large purchases are not uncommon for the consumer 104.

Once the processing server 102 has identified the verified buyer rating for the consumer 104 for the proposed payment transaction, the processing server 102 may provide the verified buyer rating back to the merchant 106 using a suitable communication network and method, for example, via the application programming interface provided by the processing server 102 for use by the merchant 106. The merchant 106 may then determine whether or not to proceed with the payment transaction based on the consumer's verified buyer rating. For example, the merchant 106 may determine to proceed with any proposed payment transaction where the consumer 104 has a verified buyer rating above a predetermined threshold value, such as 50 on a scale of 0 to 100, and to decline any other payment transaction. In some cases, the merchant 106 may request additional information or concessions from the consumer 104 if their verified buyer rating is below the predetermined threshold value, such as additional charges, placing a hold on the item until the transaction has cleared, etc. In some embodiments, merchants 106 may offer discounts or other incentives to consumer 104 based on their verified buyer ratings.

In some embodiments, the processing server 102 may be configured to generate recommendations for merchants 106. Recommendations may be generated based on the verified buyer rating determined for a proposed payment transaction as well as any other available data, such as criteria provided by the merchant 106. For instance, the merchant 106 may provide their predetermined threshold value for verified buyer ratings. In some cases, merchants 106 may provide weighting for the transactional metrics used in determining the verified buyer rating such that certain transaction metrics may have a lighter or heavier importance. For example, a merchant 106 may place a greater emphasis on transaction frequency, average transaction amount, or metrics specific to the industry of the merchant 106, when determining the verified buyer rating. When generating a recommendation, the processing server 102 may use the verified buyer rating as well as any information provided by the merchant 106. The recommendation may include a recommendation whether to approve or decline the payment transaction as well as the verified buyer rating and one or more of the transactional metrics used to generate the verified buyer rating.

In the above first example, the recommendation from the processing server 102 to the merchant 106 may include the verified buyer rating, the transaction frequency for the consumer 104 at sporting goods stores, and the average spend of the consumer 104 at sporting goods stores, illustrating to the merchant 106 why the consumer 104 was given a verified buyer rating of 95 along with a recommendation to approve the proposed payment transaction. In the above third example, the recommendation may also include the transaction frequency for transactions greater than $1000 for the consumer 104. In such embodiments, the additional information in the recommendation may be used by the merchant 106 in addition to the verified buyer rating.

In some embodiments, the processing server 102 may be configured to perform one or more actions on behalf of the merchant 106 based on the verified buyer rating. In one example, the merchant 106 or acquirer 110 may provide the authorization request to the processing server 102. The processing server 102 may generate the verified buyer rating, for example, by applying one or more machine learning algorithms on at least the past transaction data, and submit the authorization request to the payment network 112 for processing if the verified buyer rating is above a predetermined threshold value provided by the merchant 106 or acquirer 110, or decline the payment transaction and provide an authorization response indicating accordingly if the verified buyer rating is below the predetermined threshold value. In another example, in cases where the processing server 102 is part of the payment network 112 and receives the authorization request during processing, the processing server 102 may similarly continue routing of the authorization request if the verified buyer rating is above the predetermined threshold value or return an authorization response declining the payment transaction if the verified buyer rating is below the predetermined threshold value. In cases where the processing server 102 declines the proposed payment transaction as a result of an insufficient verified buyer rating, the response code included in the authorization response may indicate the verified buyer rating as a reason for the decline.

In some embodiments, the processing server 102 may require consent from consumers 104 prior to use of transaction history or other data in the generation of a verified buyer rating. In such embodiments, the processing server 102 may communicate with consumers 104 directly using any suitable communication network or method or via issuers 108 or other entities to receive consent to obtain and/or utilize data in the generation of a verified buyer rating. In some cases, consumers 104 may provide consent to the data that is collected by the processing server 102, such as by authorizing user or release of their transaction history or other data. In some instances, all data stored by the processing server 102 in account profiles may not include any personally identifiable information, even with consent of the associated individual. In some embodiments, merchants 106 may offer discounts or other incentives to consumers 104 that provide consent for their data to be collected and used in verified buyer ratings. For example, a merchant 106 can offer a 5% discount on all purchases for consumers 104 that have a verified buyer rating, encouraging consumers 104 to provide consent to the processing server 102. In such an example, a merchant 106 may offer a greater discount of 10% for consumers 104 that have a verified buyer rating above a specific value, further encouraging consumers 104 to engage in positive transaction behavior and/or to provide additional data used to increase their verified buyer rating.

The processing server 102 may be configured to obtain data for use in generated verified buyer ratings from any suitable source. Data for past payment transactions may be received from merchants 106, acquirers 110, issuers 108, payment networks 112, or other sources. The processing server 102 may also be configured to obtain any other data that can be useful in generating verified buyer ratings from third party data providers 114. Third party data providers 114 may be any entity that has data available for use by the processing server 102 (e.g., in compliance with any data collection and usage laws and regulations, with consent of the consumer 104, etc.). Third party data providers 114 may include online marketplaces, credit bureaus, data collection agencies, governmental agencies, etc. The processing server 102 may use any of the data collected from third party data providers 114 in an account profile for use in generating a verified buyer rating.

For example, the processing server 102 may use a consumer's credit rating in generating the verified buyer rating, where a higher credit score can increase the verified buyer rating. In another example, the processing server 102 may identify (e.g., based on information provided by the consumer 104, such as an e-mail address) accounts of the consumer 104 on online marketplaces and use feedback and ratings from the online marketplaces in generating the verified buyer rating. For instance, a consumer 104 that has positive ratings as a buyer on multiple online marketplaces can have a greater verified buyer rating than a consumer 104 that has limited history or negative ratings on online marketplaces. In some cases, the processing server 102 may use pattern-matching algorithms to analyze comments left by sellers on consumer accounts on online marketplaces for keywords, texts or other information that can be used to affect the verified buyer rating. For instance, multiple reviews of the consumer 104 as a buyer on marketplaces that refer to the consumer 104 charging back the purchase can negatively affect the consumer's verified buyer rating.

In some cases, geographic location data may be used in generating the verified buyer rating. For example, if a proposed payment transaction is in the same geographic area as a large number of past payment transactions involving the consumer 104, the verified buyer rating could be higher, whereas if the proposed payment transaction is in a different country from all prior transactions involving the consumer 104 then the verified buyer rating could be significantly lower due to a high likelihood of fraud. In some cases, a consumer 104 may consent to have the geographic location of their computing device made accessible to the processing server 102, such as the location of their smart phone when making a purchase. In such cases, the location of their smart phone can be compared to the geographic location of the proposed payment transaction, which can have a significant effect on the verified buyer rating.

In some embodiments, the processing server 102 may be configured to combine account profiles for multiple transaction accounts that have the same consumer 104 as an authorized user or may otherwise utilize data from multiple account profiles that have the same consumer 104 as an authorized user when generating a verified buyer rating. For example, one consumer 104 can be issued multiple transaction accounts from one or more issuers 108. The processing server 102 may link the account profiles based on data provided by the consumer 104 or data common to the account profiles, such as a common e-mail address as contact information, common billing address, etc. In such embodiments, the additional data may be used to provide a more accurate verified buyer rating. For instance, in the above third example, the consumer 104 can have a second transaction account that they commonly use for large purchases at sporting goods stores of over $1000. By linking the second transaction account to the one used in the proposed payment transaction and identifying its history of similar purchases, the processing server 102 may generate a very high verified buyer rating as the purchase is a common one for that consumer 104, they are just using a different payment method than usual for the larger purchase, while the payment method still being one commonly used by that consumer 104.

In some embodiments, insurance may be provided to merchants 106 for proposed payment transactions based on verified buyer ratings. For example, an insurance agency may provide insurance to a merchant 106 to cover losses in transactions where the coverage is based on use of verified buyer ratings. A merchant 106 may pay premiums to an insurance agency that can compensate the merchant 106 for any fraudulent transaction when the merchant 106 proceeds with transactions with a verified buyer rating above a predetermined threshold value provided by the insurance agency. This can provide for even greater protection to merchants 106 that can not only feel more confident in proceeding with transactions as a result of verified buyer ratings, but also know that they can be covered for fraudulent transactions that can still occur.

The methods and systems discussed herein provide for the generation of verified buyer ratings for proposed payment transactions. By utilizing transaction history and other available data, the processing server 102 can generate a verified buyer rating that indicates the likelihood a buyer will successfully fund a proposed payment transaction for use by a merchant 106. As the transaction history is based on use of the transaction account and is not tied to any specific marketplace, the verified buyer rating can be both more accurate than traditional ratings found on online marketplaces and also available to any merchant 106 regardless of the marketplace used for the proposed transaction. In other words, merchants are provided protection that is platform agnostic. As a result, merchants 106 can proceed in transactions with consumers 104 with greater confidence and with less likelihood of being defrauded, while consumers 104 can participate in new marketplaces with greater success as a result of their positive transaction activity, providing benefit to all participants and without the need for consumers 104 or merchants 106 to do more than their normal transaction processes.

### Processing Server

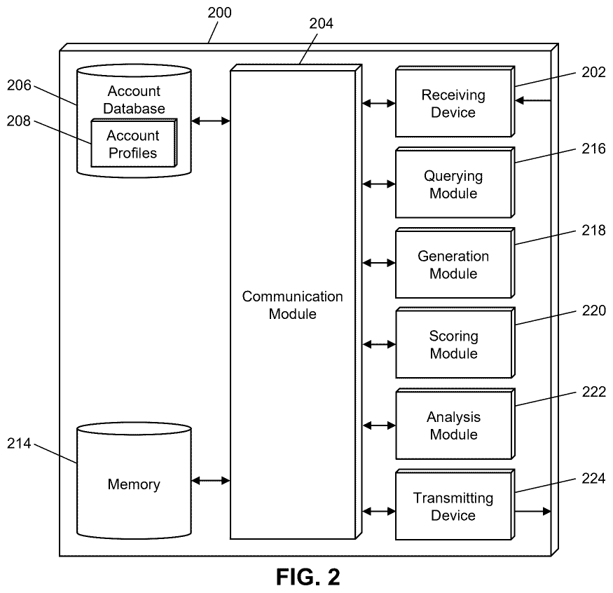

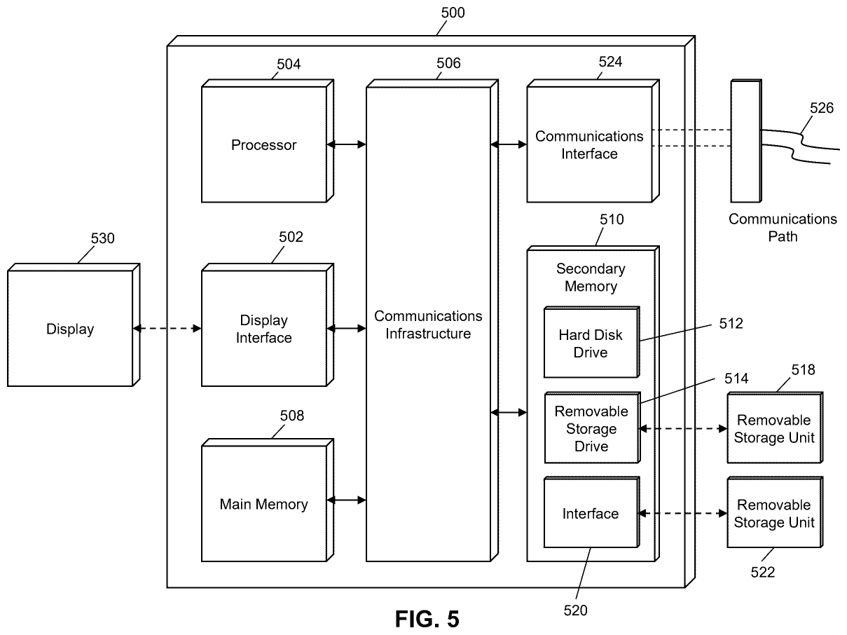

FIG. 2 illustrates an embodiment of the processing server 102 of the system 100 of FIG. 1. It will be apparent to persons having skill in the relevant art that the embodiment of the computing system 200 illustrated in FIG. 2 is provided as illustration only and cannot be exhaustive to all possible configurations of the computing system 200 suitable for performing the functions as discussed herein. For example, the computer system 500 illustrated in FIG. 5 and discussed in more detail below can be a suitable configuration of the processing server 102.

The processing server 102 may include a receiving device 202. The receiving device 202 may be configured to receive data over one or more networks via one or more network protocols. In some instances, the receiving device 202 may be configured to receive data from merchants 106, issuers 108, acquirers 110, payment networks 112, third party data providers 114, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data can be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by merchants 106 or acquirers 110 that can be superimposed or otherwise encoded with verified buyer score requests that can include transaction account identifiers and transaction data. The processing server 102 may also be configured to receive data signals electronically transmitted by merchants 106, acquirers 110, or payment networks 112, which can be superimposed or otherwise encoded with authorization requests or other transaction messages. The processing server 102 may also be configured to receive data signals electronically transmitted by merchants 106, issuers 108, acquirers 110, payment networks 112, or third party data providers 114 that are superimposed or otherwise encoded with transaction data for past payment transactions. The processing server 102 may also be configured to receive data signals electronically transmitted by third party data providers 114, which can be superimposed or otherwise encoded with data for use in generating verified buyer ratings, such as credit ratings, geographic location data, online marketplace data, social network data, etc.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 216, generation module 218, scoring module 220, analysis module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may also include an account database 206. The account database 206 may be configured to store one or more account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a transaction account. An account profile 208 may include, for example, an account identifier, payment details, transaction data for a plurality of past payment transactions, geographic location data, computing device data, online marketplace data, past verified buyer ratings, etc.

The processing server 102 may also include a memory 214. The memory 214 may be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, device profiles, cryptographic keys including public keys and/or private keys, communication data, encryption algorithms, scoring algorithms, machine learning algorithms, pattern-matching algorithms, transaction data, transaction message standards, transaction message formatting rules, etc.

The processing server 102 may include a querying module 216. The querying module 216 may be configured to execute queries on databases to identify information. The querying module 216 may receive one or more data values or query strings and can execute a query string based thereon on an indicated database, such as the account database 206 of the processing server 102 to identify information stored therein. The querying module 216 may then output the identified information to an appropriate engine or module of the processing server 102 as necessary. The querying module 216 may, for example, execute a query on the account database 206 to identify an account profile 208 associated with a transaction account used in a proposed payment transaction for which a verified buyer score request is received.

The processing server 102 may also include a generation module 218. The generation module 218 may be configured to generate data for use by the processing server 102 in performing the functions discussed herein. The generation module 218 may receive instructions as input, may generate data based on the instructions, and may output the generated data to one or more modules of the processing server 102. For example, the generation module 218 may be configured to generate transaction messages, recommendation messages, notification messages, transactional metrics, etc.

The processing server 102 may also include a scoring module 220. The scoring module 220 may be configured to generate verified buyer scores for the processing server 102 as part of the functions discussed herein. The scoring module 220 may receive instructions as input, may generate scores as instructed, and may output a result of the scoring to one or more modules of the processing server 102. In some cases, the input can include the data to be used in the scoring. In other cases, the scoring module 220 may be configured to identify such data, such as in the account database 206 and/or memory 214. The scoring module 220 may be configured to, for example, generate verified buyer ratings based on transactional metrics and other data available to the processing server 102. In some embodiments, the scoring module 220 generates verified buyer ratings by applying a machine-learning algorithm stored in the memory 214 on at least transaction history included in an identified account profile.

The processing server 102 may also include an analysis module 222. The analysis module 222 may be configured to analyze data for the processing server 102 as part of the functions discussed herein. The analysis module 222 may receive instructions as input, analyze data as instructed, and output a result of the analysis to one or more modules of the processing server 102. In some cases, the input can include the data to be analyzed or for use in the analysis. In other cases, the analysis module 222 can be configured to identify such data, such as in the memory 214. The analysis module 222 may be configured to analyze online marketplace data, social network data, and other available data to identify data for use in verified buyer ratings, such as analyzing (e.g., using a pattern-matching algorithm) feedback and comments on online marketplaces for keywords or other values.

The processing server 102 may also include a transmitting device 224. The transmitting device 224 may be configured to transmit data over one or more networks via one or more network protocols. In some instances, the transmitting device 224 may be configured to transmit data to merchants 106, issuers 108, acquirers 110, payment networks 112, third party data providers 114, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that can be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to merchants 106, acquirers 110, or payment network 112 that are superimposed or otherwise encoded with verified buyer ratings, recommendation messages, authorization requests, authorization responses, etc. The transmitting device 224 may also be configured to electronically transmit data signals to merchant 106, issuers 108, acquirers 110, payment networks 112, or third party data providers 114, which can be superimposed or otherwise encoded with data requests, such as requests for transaction data, requests for online marketplace data, requests for consumer consent, etc.

### Process for Using a Verified Buyer Rating

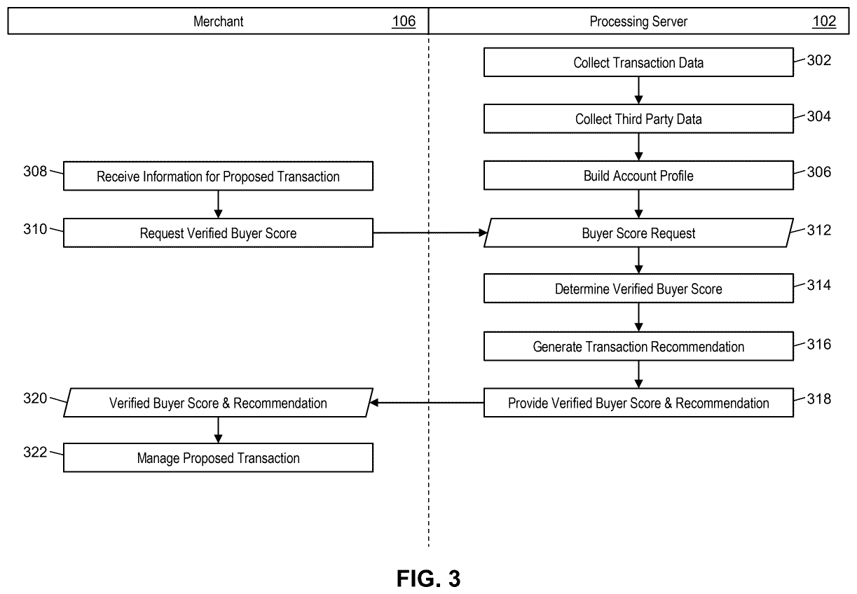

FIG. 3 illustrates a process in the system 100 of FIG. 1 for the user of a verified buyer rating based on past transaction history and other data in a proposed payment transaction.

In step 302, the receiving device 202 of the processing server 102 may receive historical transaction data for a plurality of past payment transactions for a transaction account, such as from merchants 106, issuers 108, acquirers 110, payment networks 112, and third party data providers 114. In step 304, the receiving device 202 of the processing server 102 may receive third party data from third party data providers 114 that is associated with the transaction account, such as online marketplace data, geographic location data, etc. In step 306, the querying module 216 of the processing server 102 may execute a query on the account database 206 of the processing server 102 to insert the historical transaction data and the third party data into account profile 208 associated with the transaction account.

In step 308, the merchant 106 may receive transaction information and other data for a proposed payment transaction involving the consumer 104 including payment details for the transaction account selected for use to fund the payment transaction by the consumer 104, the payment details including at least an account identifier. In step 310, the merchant 106 may electronically transmit a request for a verified buyer score to the processing server 102 using a suitable communication network and method. The request may include at least the account identifier and the transaction information for the proposed payment transaction. In step 312, the receiving device 202 of the processing server 102 may receive the verified buyer score request.

In step 314, the generation module 218 of the processing server 102 may generate one or more transactional metrics based on the historical transaction data stored in the account profile 208 associated with the transaction account, a comparison of the historical transaction data with the transaction information for the proposed payment transaction, and any other data stored in the account profile 208. For example, the generation module 218 may apply a machine learning algorithm on the historical transaction data and compare the historical transaction data with the transaction information. The scoring module 220 of the processing server 102 may generate a verified buyer score based on the one or more generated transactional metrics. In step 316, the generation module 218 of the processing server 102 may generate a recommendation for the proposed payment transaction based on at least the verified buyer score, where the recommendation can include the verified buyer score and at least one of the one or more transactional metrics.

In step 318, the transmitting device 224 of the processing server 102 may electronically transmit the generated recommendation with the verified buyer score to the merchant 106 using a suitable communication network and method. In step 320, the merchant 106 may receive the recommendation and verified buyer score. In step 322, the merchant 106 may then determine whether or not to proceed with the proposed payment transaction based on the received recommendation and verified buyer score. For instance, if the verified buyer score is above a predetermined threshold value, the merchant 106 may submit an authorization request for the payment transaction to the payment network 112 via payment rails thereof. If the verified buyer score is below a predetermined threshold value, the merchant 106 may decline the proposed payment transaction.

### Exemplary Method for Generating a Verified Buyer Rating

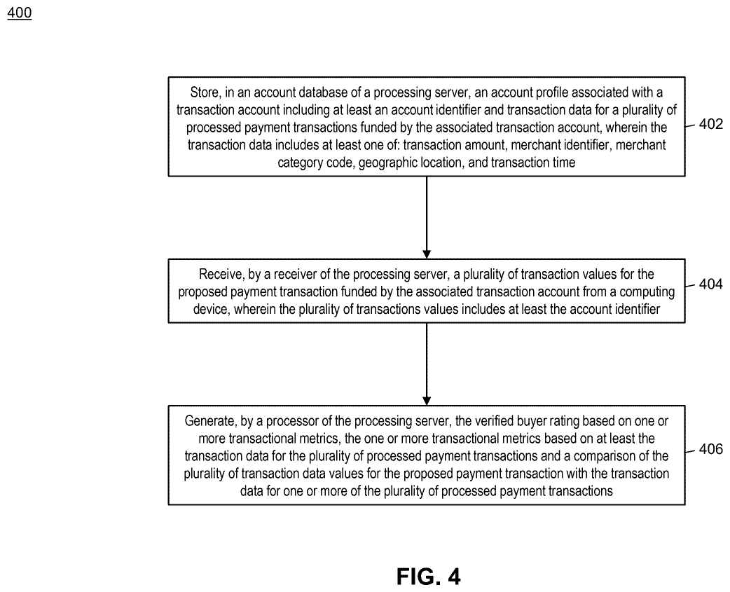

FIG. 4 illustrates a method 400 for the generation of a verified buyer rating in a proposed payment transaction.

In step 402, an account profile (e.g., account profile 208) associated with a transaction account may be stored in an account database (e.g., account database 206) of a processing server (e.g., processing server 102), the account profile including at least an account identifier and transaction data for a plurality of processed payment transactions funded by the associated transaction account, wherein the transaction data includes at least one of: transaction amount, merchant identifier, merchant category code, geographic location, and transaction time. In step 404, a plurality of transaction values for the proposed payment transaction funded by the associated transaction account may be received by a receiver (e.g., receiving device 202) of the processing server from a computing device (e.g., merchant 106), wherein the plurality of transaction values includes at least the account identifier. In step 406, the verified buyer rating may be generated by a processor (e.g., generation module 218, scoring module 220, etc.) of the processing server based on one or more transactional metrics, the one or more transactional metrics based on at least the transaction data for the plurality of processed payment transactions and a comparison of the plurality of transaction data values for the proposed payment transaction with the transaction data for one or more of the plurality of processed payment transactions.

In one embodiment, the method 400 may also include transmitting, by a transmitter (e.g., transmitting device 224) of the processing server, the generated verified buyer rating to the computing device in response to the received plurality of transaction values. In a further embodiment, the transmission to the computing device may further include a recommendation to process the proposed payment transaction when the generated verified buyer rating is above a predetermined threshold value. In another further embodiment, the transmission to the computing device may further include a recommendation to decline the proposed payment transaction when the generated verified buyer rating is below a predetermined threshold value. In an even further embodiment, the recommendation may further include at least one of the one or more transactional metrics.

In some embodiments, the plurality of transaction values for the proposed payment transaction may be received in an authorization request for the proposed payment transaction, and the method 400 may further include transmitting, by a transmitter of the processing server, the authorization request to a second computing device (e.g., issuer 108, acquirer 110, payment network 112, etc.) for authorization when the generated verified buyer rating is above a predetermined threshold value or transmitting, by the transmitter of the processing server, an authorization response declining the proposed payment transaction to the computing device when the verified buyer rating is below a predetermined threshold value. In one embodiment, the account profile may further include one or more additional data values associated with at least one of: the transaction account and an entity authorized for use of the transaction account, and the one or more transactional metrics can be further based on the one or more additional values. In a further embodiment, the one or more additional values can include at least one of: credit ratings, billing addresses, shipping addresses, names, marketplace ratings, marketplace feedback, dispute history, chargeback history, return history, and computing device data.

### Computer System Architecture

FIG. 5 illustrates a computer system 500 in which embodiments of the present disclosure, or portions thereof, can be implemented as computer-readable code. For example, the processing server 102, merchant 106, issuer 108, acquirer 110, and third party data provider 114 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3 and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3 and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for generating a verified buyer rating for a buyer in a proposed payment transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for generating a verified buyer rating for a buyer in a proposed payment transaction, comprising:
storing, in an account database of a processing server, an account profile associated with a transaction account including at least an account identifier and transaction data for a plurality of processed payment transactions funded by the associated transaction account, wherein the transaction data includes at least one of: transaction amount, merchant identifier, merchant category code, geographic location, and transaction time;
receiving, by a receiver of the processing server, a plurality of transaction values for the proposed payment transaction funded by the associated transaction account from a computing device, wherein the plurality of transactions values includes at least the account identifier; and
generating, by a processor of the processing server, the verified buyer rating based on one or more transactional metrics, the one or more transactional metrics based on at least the transaction data for the plurality of processed payment transactions and a comparison of the plurality of transaction data values for the proposed payment transaction with the transaction data for one or more of the plurality of processed payment transactions.

2. The method of claim 1, further comprising:
transmitting, by a transmitter of the processing server, the generated verified buyer rating to the computing device in response to the received plurality of transaction values.

3. The method of claim 2, wherein the transmission to the computing device further includes a recommendation to process the proposed payment transaction when the generated verified buyer rating is above a predetermined threshold value.

4. The method of claim 2, wherein the transmission to the computing device further includes a recommendation to decline the proposed payment transaction when the generated verified buyer rating is below a predetermined threshold value.

5. The method of claim 4, wherein the recommendation further includes at least one of the one or more transactional metrics.

6. The method of claim 1, wherein
the plurality of transaction values for the proposed payment transaction are received in an authorization request for the proposed payment transaction, and
the method further comprises:
transmitting, by a transmitter of the processing server, the authorization request to a second computing device for authorization when the generated verified buyer rating is above a predetermined threshold value; or
transmitting, by the transmitter of the processing server, an authorization response declining the proposed payment transaction to the computing device when the verified buyer rating is below a predetermined threshold value.

7. The method of claim 1, wherein
the account profile further includes one or more additional data values associated with at least one of: the transaction account and an entity authorized for use of the transaction account, and
the one or more transactional metrics are further based on the one or more additional values.

8. The method of claim 7, wherein the one or more additional values includes at least one of: credit ratings, billing addresses, shipping addresses, names, marketplace ratings, marketplace feedback, dispute history, chargeback history, return history, and computing device data.

9. A system for generating a verified buyer rating for a buyer in a proposed payment transaction, comprising:
a computing device; and
a processing server, the processing server including
an account database storing an account profile associated with a transaction account including at least an account identifier and transaction data for a plurality of processed payment transactions funded by the associated transaction account, wherein the transaction data includes at least one of: transaction amount, merchant identifier, merchant category code, geographic location, and transaction time,
a receiver receiving a plurality of transaction values for the proposed payment transaction funded by the associated transaction account from the computing device, wherein the plurality of transactions values includes at least the account identifier, and
a processor generating the verified buyer rating based on one or more transactional metrics, the one or more transactional metrics based on at least the transaction data for the plurality of processed payment transactions and a comparison of the plurality of transaction data values for the proposed payment transaction with the transaction data for one or more of the plurality of processed payment transactions.

10. The system of claim 9, wherein the processing server further includes a transmitter transmitting the generated verified buyer rating to the computing device in response to the received plurality of transaction values.

11. The system of claim 10, wherein the transmission to the computing device further includes a recommendation to process the proposed payment transaction when the generated verified buyer rating is above a predetermined threshold value.

12. The system of claim 10, wherein the transmission to the computing device further includes a recommendation to decline the proposed payment transaction when the generated verified buyer rating is below a predetermined threshold value.

13. The system of claim 12, wherein the recommendation further includes at least one of the one or more transactional metrics.

14. The system of claim 9, further comprising:
a second computing device, wherein
the plurality of transaction values for the proposed payment transaction are received in an authorization request for the proposed payment transaction,
the processing server further includes a transmitter
transmitting the authorization request to the second computing device for authorization when the generated verified buyer rating is above a predetermined threshold value, or
transmitting an authorization response declining the proposed payment transaction to the computing device when the verified buyer rating is below a predetermined threshold value.

15. The system of claim 9, wherein
the account profile further includes one or more additional data values associated with at least one of: the transaction account and an entity authorized for use of the transaction account, and
the one or more transactional metrics are further based on the one or more additional values.

16. The system of claim 15, wherein the one or more additional values includes at least one of: credit ratings, billing addresses, shipping addresses, names, marketplace ratings, marketplace feedback, dispute history, chargeback history, return history, and computing device data.

17. A method for processing financial transactions using verified buyer ratings, the method comprises:
communicating, by a first computing device, with a second computing device, and receiving, from the second computing device, payment details associated with a payment transaction initiated by the second computing device with the first computing device, wherein the payment details include at least a transaction account identifier;
prior to submitting an authorization request to a payment network for processing, transmitting, by the first computing device, via an application programming interface, a verified buyer rating request to a processing server, wherein the verified buyer rating request includes at least the transaction account identifier included in the received payment details, and wherein said processing server generates a verified buyer rating on a basis of applying a machine learning algorithm on at least a transaction history of a transaction account associated with the transaction account identifier;
receiving, by the first computing device, the verified buyer rating, via the application programming interface from the processing server, wherein the verified buyer rating indicates a likelihood of a successfully funded transaction; and
determining, by the first computing device, whether to proceed with the payment transaction on a basis of a value of the verified buyer rating relative to a predetermined threshold value,
wherein when the value of the verified buyer rating exceeds the predetermined threshold value, the method further includes automatically proceeding, by the first computing device, with the payment transaction by transmitting an authorization request to a payment network for processing.

18. The method of claim 17, wherein when the value of the verified buyer rating is below the predetermined threshold value, (i) declining, by the first computing device, the payment transaction or (ii) requesting, by the first computing device, additional information from the consumer.

19. The method of claim 17, wherein the first computing device is a computing system associated with a merchant.

20. A system for processing financial transactions using verified buyer ratings, said system comprising:
a receiving device, of a first computing device, configured to communicate with a second computing device, and receive, from the second computing device, payment details associated with a payment transaction initiated by the second computing device with the first computing device, wherein the payment details include at least a transaction account identifier;
a transmitting device, of the first computing device, configured to transmit, via an application programming interface, prior to submitting an authorization request to a payment network for processing, a verified buyer rating request to a processing server, wherein the verified buyer rating request includes at least the transaction account identifier included in the received payment details, and wherein said processing server generates a verified buyer rating on a basis of applying a machine learning algorithm on at least a transaction history of a transaction account associated with the transaction account identifier; and
a processing device, of the first computing device, wherein
the receiving device is further configured to receive the verified buyer rating, via the application programming interface, from the processing server, said verified buyer rating indicating a likelihood of a successfully funded transaction,
the processing device is configured to
determine whether to proceed with the payment transaction on a basis of a value of the verified buyer rating relative to a predetermined threshold value, and
automatically proceed with the payment transaction, when the value of the verified buyer rating exceeds the predetermined threshold value, by transmitting an authorization request to a payment network for processing.

21. The system of claim 20, wherein when the value of the verified buyer rating is below the predetermined threshold value, the processing device, of the first computing device, is configured to (i) decline the payment transaction or (ii) request additional information from the consumer.

22. The system of claim 20, wherein the first computing device is a computing system associated with a merchant.
